(19) United States
(12) Patent Application Publication
(10) Pub. No.: US 2022/0313389 A1
(43) Pub. Date: Oct. 6, 2022

(54) DENTAL POLISHING INSTRUMENT HAVING INCREASED SERVICE LIFE

(71) Applicant: GEBR. BRASSELER GMBH & CO. KG, Lemgo (DE)

(72) Inventor: Michael KÜLLMER, Lemgo (DE)

(21) Appl. No.: 17/628,482

(22) PCT Filed: May 26, 2020
(86) PCT No.: PCT/EP2020/064526

§ 371 Date: Jan. 19, 2022

(30) Foreign Application Priority Data
Jul. 26, 2019 (DE) 10 2019 211 163.7

(51) Int. Cl. A61C 3/06

(52) U.S. Cl. CPC A61C 3/06

(57) ABSTRACT

The invention relates to a dental grinding instrument including a shaft and a grinding area arranged on the shaft, wherein the grinding area has a bonding layer and grinding elements including abrasive grains and spheres, and wherein the grinding elements are fixed to the shaft by means of the bonding layer.

The invention relates to a dental grinding instrument for use on teeth or dental prostheses such as fillings, crowns, bridges, dental implants, etc.

When processing teeth or dental prostheses, dental grinding instruments of a wide variety of geometric shapes are used, among others. The dental grinding instruments comprise a shaft and a grinding area which is covered with abrasive particles. For example, these particles can be diamond particles or hard metal particles or the like. Such a dental grinding instrument is known, for example, from DE 10 2017 202 407 A1. Usage of the dental grinding instrument results in wear off thereof, so that the dental grinding instrument is required to be replaced after a certain period of usage. In this regard, it would be desirable if a useful life of the dental grinding instrument can be extended.

It is therefore the object of the invention to provide a dental grinding instrument which has a longer service live, thus having a longer useful life, and having a simple structure and is of simple, inexpensive manufacturability.

This object will be solved by a dental grinding instrument having the features of claim 1. The subclaims show preferred further developments of the invention.

In contrast, the dental grinding instrument according to the invention having the features of claim 1 has the advantage that a service live and thus a useful life of the dental grinding instrument is significantly extended compared to the dental grinding instruments used to date. According to the invention, this will be achieved by the dental grinding instrument having a shaft and a grinding area which is arranged on the shaft. The grinding area comprises grinding elements, which are formed as abrasive grains and spheres. The grinding area further comprises a bonding region which fixes the grinding elements to the shaft.

Thus, the grinding area does not only comprise abrasive grains like in prior art but a mixture of abrasive grains and spheres. Basically, it is true that the spheres reduce the number of active cutting edges, since the number of abrasive grains is reduced, compared with a grinding area comprising exclusively abrasive grains. However, the spheres enable reduction in temperature at the grinding area due to the small spaces thus obtained, so that wear of the abrasive grains is significantly reduced. As a result, lifetime of the abrasive grains and thus the dental grinding instrument as a whole will significantly be extended.

Preferably, a proportion of the spheres in the abrasive elements is in a range from 15% by volume to 45% by volume. Preferably, the proportion of the spheres is in a range from 20% by volume to 40% by volume, further preferably in a range from 25% by volume to 35% by volume. Particularly preferably, the proportion of spheres in the abrasive elements is 30% by volume. In each case, the proportion of abrasive grains is the remaining volume fraction. That is, if the grinding elements comprise 30% by volume spheres, 70% by volume thereof will be abrasive grains.

Another increase in the service live of the dental grinding instrument will be achieved if the spheres are preferably hollow. The use of hollow spheres thus enables another extension of the service live of the dental grinding instrument.

The hollow spheres preferably have a wall thickness in a range from 1/7 to ⅕ of the sphere diameter, and particularly preferably have a wall thickness of about ⅙ of the sphere diameter.

According to another preferred embodiment of the invention, a first diameter of the spheres is always smaller than an average second diameter of the abrasive grains.

Preferably, the abrasive grains are diamond grains and/or DLC grains and/or carbide grains.

Further preferably, the spheres are made of ceramic material. As the ceramic material, alumina is particularly preferred. Instead of aluminum oxide ceramic material, zirconium oxide ceramic material or a mixture of both ceramics may also preferably be used.

Particularly good fixation of the grinding elements to the shaft is obtained if the bonding area comprises nickel. Nickel formation can be provided by simple manufacturing processes on the shaft and may fix the grinding elements.

Further preferably, the spheres are evenly distributed across the surface of the grinding area. This especially avoids heat islands during machining, so that there will be uniform wear of the dental grinding instrument over time.

The dental grinding instrument according to the invention is thus suitable for machining both teeth and dental prostheses of any form.

A preferred embodiment of the invention will be described in detail below while making reference to the accompanying drawings, wherein:

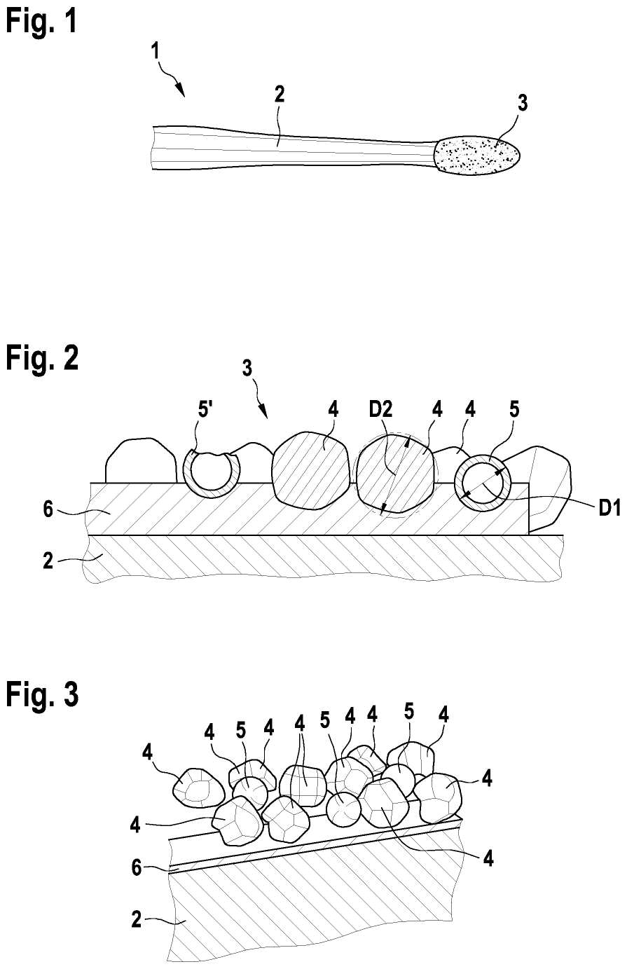

FIG. 1 is a schematic view of a dental grinding instrument according to a preferred embodiment of the invention,

FIG. 2 is a schematic sectional view of the grinding area of the dental grinding instrument of FIG. 1,

FIG. 3 is a theoretical exploded perspective view of the grinding area of FIG. 2, and

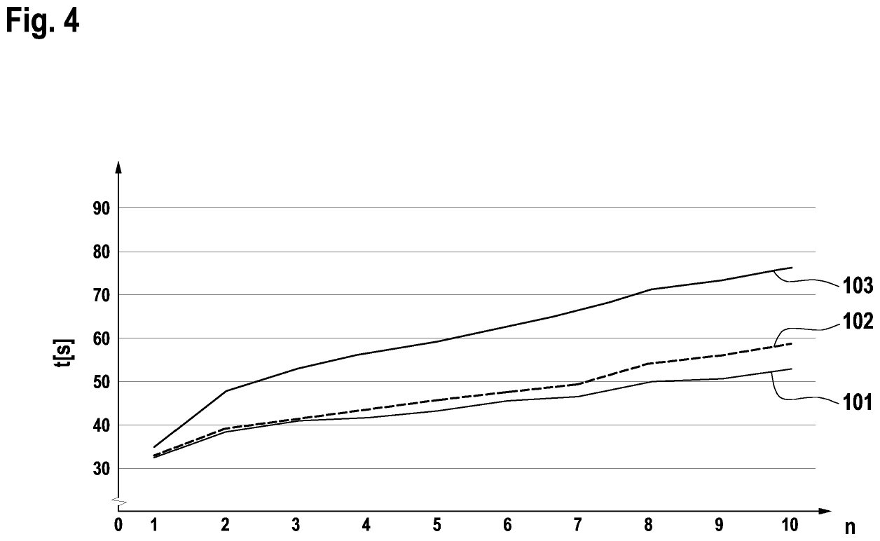

FIG. 4 is a diagram showing a grinding time t over a number of trials n of a grinding test over a constantly equal distance in comparison with two conventional dental grinding instruments.

In the following, a dental grinding instrument 1 according to a preferred embodiment of the invention will be described in detail while making reference to FIGS. 1 to 4,

As may be seen from FIG. 1, the dental grinding instrument 1 comprises a shaft 2 and a grinding area 3. The grinding area 3 is fixed to the shaft 2.

As may be seen in detail from FIG. 2, the grinding area 3 comprises a bond layer 6 and a plurality of grinding elements. The grinding elements are partially embedded in the bonding layer 6, which is applied to the shaft 2, and thus will be fixed to the dental grinding instrument 1.

As may be seen from FIGS. 2 and 3, the grinding elements herein comprise abrasive grains 4 and spheres 5. No other grinding elements are provided. In this example embodiment, 30% by volume spheres and 70% by volume abrasive grains are provided herein.

The abrasive grains 4 are diamond grains and the spheres 5 are made of an alumina ceramic material.

As may be seen from FIG. 2, the spheres 5 are hollow. Herein, a first diameter D1 of the spheres 5 is smaller than an average second diameter D2 of the abrasive grains 4.

This results in larger interstices between adjacent abrasive grains 4 in which spheres 5 are arranged. Thus, during processing using the dental grinding instrument, a temperature at the surface of the dental grinding instrument can significantly be reduced compared to the dental grinding instruments previously used, which are solely comprised of abrasive grains. This temperature reduction enables significant extension of a service life of the dental grinding instrument according to the invention.

In FIG. 2, reference number 5′ schematically indicates a broken sphere. When machining the surface of the tooth or the like, damage to the spheres 5 may also occur. However, such damage does not affect the abrasive properties of the abrasive grains 4.

Turning now to FIG. 3, it illustrates in schematic perspective view how the grinding elements, i.e. the abrasive grains 4 and the spheres 5, are fixed to the shaft 2 by means of the bonding layer 6.

FIG. 4 shows a diagram showing a comparison between a dental grinding instrument according to the invention and two prior art dental grinding instruments. In the comparative test, the dental grinding instruments were guided over a predetermined constant test distance and were operated in rotation over a certain number of times n, in this example 10 times. For each test, a time t in seconds was determined in which the dental grinding instrument is to be guided over the predetermined constant distance so as to obtain a predetermined constant surface quality.

In FIG. 4, a first curve 101 is drawn for the dental grinding instrument 1 according to the invention. As a comparison, a second curve 102 is drawn for a dental prior art grinding instrument, which has a specific diamond coating that has specifically been developed for machining zirconium ceramics. A third curve 103 shows the behavior of a dental grinding instrument which solely comprises diamond grains as abrasive grains.

As may be seen from FIG. 4, in the first test (n=1) the service lives t are very close to each other in the range from 32 seconds (curves 101 and 102) to 35 seconds (curve 103). With an increasing number of tests performed and thus concomitant increase in temperature in the dental grinding instrument, significantly longer processing times result in each case for the second curve 102 and the third curve 103. For example, in the 10th test (n=10), the dental grinding instrument according to the invention requires approximately 52 seconds. The dental grinding instrument covered with the specific diamond coating developed for zirconia machining requires approximately 58 seconds and the dental grinding instrument covered with diamond grains requires approximately 75 seconds.

This comparison reveals that there is significant increase in service life of the dental grinding instrument 1 according to the invention compared to the prior art dental grinding instruments, which are exclusively comprised of one type of abrasive grains.

It should also be noted that the geometric shape of the grinding area 3 of the dental grinding instrument 1 of the invention can be selected as desired. In FIG. 1, a bud shape is shown. However, the inventive concept is also applicable to all other geometric shapes such as cones, cylinders, spheres, clubs, ellipses, discs, etc.

### LIST OF REFERENCE NUMBERS

1 Dental grinding instrument
2 Shaft
3 Grinding area
4 Abrasive grains
5 Sphere
5′ Sphere partially destroyed during operation
6 Bonding layer
101 First curve of a dental grinding instrument according to the invention
102 Second curve with specific prior art diamond coating
103 Third curve with diamond grains only
D1 diameter of the spheres
D2 Average diameter of the abrasive grains

1. A dental grinding instrument comprising
a shaft and
a grinding area disposed on the shaft,
wherein the grinding area has a bonding layer and grinding elements comprising abrasive grains and spheres, and
wherein the grinding elements are fixed to the shaft by means of the bonding layer.

2. The dental grinding instrument according to claim 1, wherein a proportion of the spheres in the grinding elements is in a range from 15% by volume to 45% by volume, in particular 20% by volume to 40% by volume, further particularly in a range from 25% by volume to 35% by volume and further particularly 30% by volume.

3. The dental grinding instrument according to claim 1, wherein the spheres are hollow.

4. The dental grinding instrument according to claim 3, wherein the spheres have a wall thickness in a range from 1/7 of a first diameter of the spheres to ⅕ of the first diameter of the spheres.

5. The dental grinding instrument according to claim 1, wherein the first diameter of the spheres is smaller than a second average diameter of the abrasive grains.

6. The dental grinding instrument according to claim 1, wherein the abrasive grains are diamond grains and/or DLC grains and/or carbide grains.

7. The dental grinding instrument according to claim 1, wherein the spheres are made of ceramic material.

8. The dental grinding instrument according to claim 7, wherein the spheres are made of alumina, or
wherein the spheres are made of zirconium oxide, or
wherein the spheres are made of a mixed ceramic material comprising alumina and zirconia.

9. The dental grinding instrument according to claim 1, wherein the bonding layer comprises nickel.

10. The dental grinding instrument according to claim 1, wherein the spheres are evenly distributed across a surface of the grinding area.
